(19) United States
(12) Patent Application Publication
(10) Pub. No.: US 2019/0350034 A1
(43) Pub. Date: Nov. 14, 2019

(54) METHOD FOR PERFORMING EARLY DATA TRANSMISSION (EDT) PROCEDURE AND DEVICE SUPPORTING THE SAME

(71) Applicant: LG Electronics Inc., Seoul (KR)

(72) Inventors: Hyunjung CHOE, Seoul (KR); Youngdae LEE, Seoul (KR)

(21) Appl. No.: 16/409,336

(22) Filed: May 10, 2019

(30) Foreign Application Priority Data
May 10, 2018 (KR) 10-2018-0053657

(51) Int. Cl. H04W 76/27

(52) U.S. Cl. CPC H04W 76/27; H04W 80/02

(57) ABSTRACT

Provided are a method of performing EDT procedure and a device supporting the method. According to one embodiment of the present invention, the method includes: detecting, by a MAC layer of the UE, that coverage enhancement (CE) level of the UE changes during early data transmission (EDT) procedure; comparing, by the MAC layer of the UE, size of message to be transmitted and size of transmission block (TB) for the changed CE level; and informing, by the MAC layer, that the EDT procedure is canceled to a RRC layer of the UE, when the size of message to be transmitted is greater than or equal to the size of TB for the changed CE level.

### CROSS-REFERENCE TO RELATED APPLICATIONS

Pursuant to 35 U.S.C. § 119 (e), this application claims the benefit of Korean Application No. 10-2018-0053657, filed on May 10, 2018, the contents of which are all hereby incorporated by reference herein in their entirety.

### BACKGROUND OF THE INVENTION

### Field of the invention

The present invention relates to a wireless communication system, and more particularly, to a method for performing EDT procedure and a device supporting the same.

### Related Art

Efforts have been made to develop an improved 5^{th}-generation (5G) communication system or a pre-5G communication system in order to satisfy a growing demand on radio data traffic after commercialization of a 4^{th}-generation (4G) communication system. A standardization act for a 5G mobile communication standard work has been formally started in 3GPP, and there is ongoing discussion in a standardization working group under a tentative name of a new radio access (NR).

Meanwhile, an upper layer protocol defines a protocol state to consistently manage an operational state of a user equipment (UE), and indicates a function and procedure of the UE in detail. In the discussion on the NR standardization, an RRC state is discussed such that an RRC_CONNECTED state and an RRC_IDLE state are basically defined, and an RRC_INACTIVE state is additionally introduced.

With the introduction of the new RRC state (i.e., RRC-INACTIVE state) in NR, the UE may incur minimum signaling, minimize power consumption, minimize resource costs in the network. In order to support this concept in NR, the UE may also be able to transmit the data without state transition from the RRC-INACTIVE to the RRC-CONNECTED. Early data transmission (EDT) refers to the operation of transmitting data before the RRC connection setup is completed, if the size of the data to be transmitted is small. In other words, according to the early data transmission, data transmission is allowed even when the UE is not in the RRC connection state.

### SUMMARY OF THE INVENTION

According to a prior art, when the CE level changes during Msg1 transmission attempts before the completion of the EDT procedure, the size of Msg3 to be transmitted may be greater than the TB size allowed for the current CE level in the EDT parameters.

According to an embodiment of the present invention, a method performed by a user equipment (UE) in a wireless communication system is provided. The method may comprise: detecting, by a MAC layer of the UE, that coverage enhancement (CE) level of the UE changes during early data transmission (EDT) procedure; comparing, by the MAC layer of the UE, size of message to be transmitted and size of transmission block (TB) for the changed CE level; and informing, by the MAC layer, that the EDT procedure is canceled to a RRC layer of the UE, when the size of message to be transmitted is greater than or equal to the size of TB for the changed CE level.

The UE may be in radio resource control (RRC) idle state or RRC inactive state.

The EDT procedure may be transmitting the message to be transmitted to a network in the RRC idle state or RRC inactive state.

The method may further comprise: transmitting the message to be transmitted to a network after a RRC connection establishment procedure is completed.

The method may further comprise: receiving an indication indicating that a network supports the EDT procedure from the network.

The method may further comprise: receiving information on size of at least one of TBs which are mapped to each CE level, before detecting the change of the CE level of the UE.

The UE may communicate with at least one of a mobile terminal, a network or autonomous vehicles other than the UE.

According to another embodiment of the present invention, a user equipment (UE) in a wireless communication system is provided. The UE may comprise: a transceiver for transmitting or receiving a radio signal; and a processor coupled to the transceiver, the processor configured to: detect, by a MAC layer of the UE, that coverage enhancement (CE) level of the UE changes during early data transmission (EDT) procedure; compare, by the MAC layer of the UE, size of message to be transmitted and size of transmission block (TB) for the changed CE level; and inform, by the MAC layer, that the EDT procedure is canceled to a RRC layer of the UE, when the size of message to be transmitted is greater than or equal to the size of TB for the changed CE level.

The UE may be in radio resource control (RRC) idle state or RRC inactive state.

The EDT procedure may be transmitting the message to be transmitted to a network in the RRC idle state or RRC inactive state.

The processor may be further configured to: transmit the message to be transmitted to a network in RRC connected state after a RRC connection establishment procedure is completed.

The processor may be further configured to: receive an indication indicating that a network supports the EDT procedure from the network.

The processor may be further configured to: receive information on size of at least one of TBs which are mapped to each CE level, before detecting the change of the CE level of the UE.

The UE may communicate with at least one of a mobile terminal, a network or autonomous vehicles other than the UE.

According to another embodiment of the present invention, a processor for a wireless communication device in a wireless communication system is provided. The processor may be configured to control the wireless communication device to: detect, by a MAC layer of the UE, that coverage enhancement (CE) level of the UE changes during early data transmission (EDT) procedure; compare, by the MAC layer of the UE, size of message to be transmitted and size of transmission block (TB) for the changed CE level; and inform, by the MAC layer, that the EDT procedure is canceled to a RRC layer of the UE, when the size of message to be transmitted is greater than or equal to the size of TB for the changed CE level.

### BRIEF DESCRIPTION OF THE DRAWINGS

FIG. 1 shows an example of a wireless communication system to which technical features of the present invention can be applied.

FIG. 2 shows another example of a wireless communication system to which technical features of the present invention can be applied.

FIG. 3 shows a block diagram of a user plane protocol stack to which technical features of the present invention can be applied.

FIG. 4 shows a block diagram of a control plane protocol stack to which technical features of the present invention can be applied.

FIG. 5 shows examples of 5G usage scenarios to which the technical features of the present invention can be applied.

FIG. 6 shows an example of a wireless communication system to which the technical features of the present invention can be applied.

FIG. 7 shows a method for performing EDT procedure according to an embodiment of the present invention.

FIG. 8 shows a method for performing EDT procedure according to an embodiment of the present invention.

FIG. 9 shows an example of CE level change during the EDT procedure according to an embodiment of the present invention.

FIG. 10 shows more detailed UE to implement an embodiment of the present invention.

### DESCRIPTION OF EXEMPLARY EMBODIMENTS

The technical features described below may be used by a communication standard by the 3rd generation partnership project (3GPP) standardization organization, a communication standard by the institute of electrical and electronics engineers (IEEE), etc. For example, the communication standards by the 3GPP standardization organization include long-term evolution (LTE) and/or evolution of LTE systems. The evolution of LTE systems includes LTE-advanced (LTE-A), LTE-A Pro, and/or 5G new radio (NR). The communication standard by the IEEE standardization organization includes a wireless local area network (WLAN) system such as IEEE 802.11a/b/g/n/ac/ax. The above system uses various multiple access technologies such as orthogonal frequency division multiple access (OFDMA) and/or single carrier frequency division multiple access (SC-FDMA) for downlink (DL) and/or uplink (DL). For example, only OFDMA may be used for DL and only SC-FDMA may be used for UL. Alternatively, OFDMA and SC-FDMA may be used for DL and/or UL.

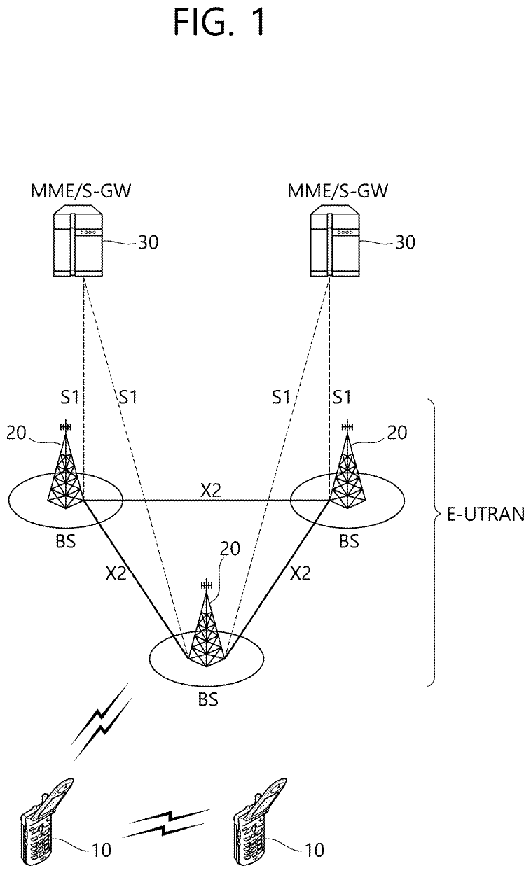

FIG. 1 shows an example of a wireless communication system to which technical features of the present invention can be applied. Specifically, FIG. 1 shows a system architecture based on an evolved-UMTS terrestrial radio access network (E-UTRAN). The aforementioned LTE is a part of an evolved-UTMS (e-UMTS) using the E-UTRAN.

Referring to FIG. 1, the wireless communication system includes one or more user equipment (UE; 10), an E-UTRAN and an evolved packet core (EPC). The UE 10 refers to a communication equipment carried by a user. The UE 10 may be fixed or mobile. The UE 10 may be referred to as another terminology, such as a mobile station (MS), a user terminal (UT), a subscriber station (SS), a wireless device, etc.

The E-UTRAN consists of one or more base station (BS) 20. The BS 20 provides the E-UTRA user plane and control plane protocol terminations towards the UE 10. The BS 20 is generally a fixed station that communicates with the UE 10. The BS 20 hosts the functions, such as inter-cell radio resource management (MME), radio bearer (RB) control, connection mobility control, radio admission control, measurement configuration/provision, dynamic resource allocation (scheduler), etc. The BS may be referred to as another terminology, such as an evolved NodeB (eNB), a base transceiver system (BTS), an access point (AP), etc.

A downlink (DL) denotes communication from the BS 20 to the UE 10. An uplink (UL) denotes communication from the UE 10 to the BS 20. A sidelink (SL) denotes communication between the UEs 10. In the DL, a transmitter may be a part of the BS 20, and a receiver may be a part of the UE 10. In the UL, the transmitter may be a part of the UE 10, and the receiver may be a part of the BS 20. In the SL, the transmitter and receiver may be a part of the UE 10.

The EPC includes a mobility management entity (MME), a serving gateway (S-GW) and a packet data network (PDN) gateway (P-GW). The MME hosts the functions, such as non-access stratum (NAS) security, idle state mobility handling, evolved packet system (EPS) bearer control, etc. The S-GW hosts the functions, such as mobility anchoring, etc. The S-GW is a gateway having an E-UTRAN as an endpoint. For convenience, MME/S-GW 30 will be referred to herein simply as a “gateway,” but it is understood that this entity includes both the MME and S-GW. The P-GW hosts the functions, such as UE Internet protocol (IP) address allocation, packet filtering, etc. The P-GW is a gateway having a PDN as an endpoint. The P-GW is connected to an external network.

The UE 10 is connected to the BS 20 by means of the Uu interface. The UEs 10 are interconnected with each other by means of the PC5 interface. The BSs 20 are interconnected with each other by means of the X2 interface. The BSs 20 are also connected by means of the S1 interface to the EPC, more specifically to the MME by means of the S1-MME interface and to the S-GW by means of the S1-U interface. The S1 interface supports a many-to-many relation between MMEs/S-GWs and BSs.

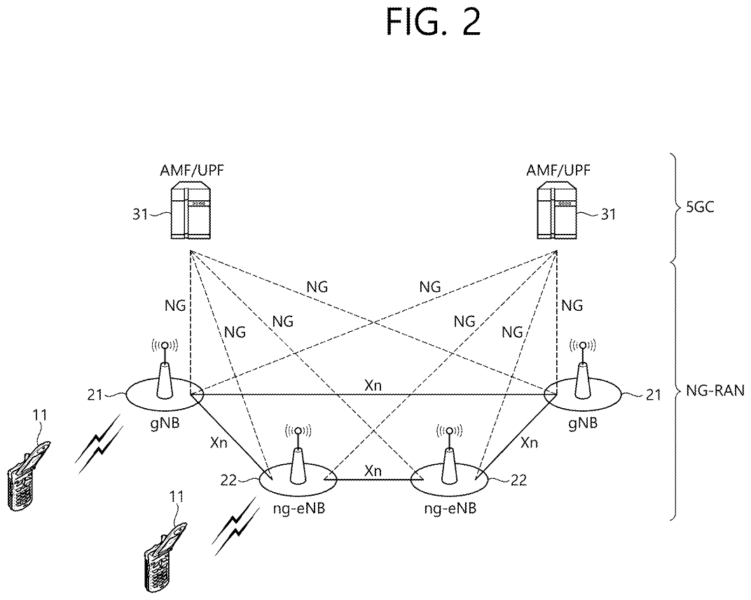

FIG. 2 shows another example of a wireless communication system to which technical features of the present invention can be applied. Specifically, FIG. 2 shows a system architecture based on a 5G new radio access technology (NR) system. The entity used in the 5G NR system (hereinafter, simply referred to as “NR”) may absorb some or all of the functions of the entities introduced in FIG. 1 (e.g. eNB, MME, S-GW). The entity used in the NR system may be identified by the name “NG” for distinction from the LTE/LTE-A.

Referring to FIG. 2, the wireless communication system includes one or more UE 11, a next-generation RAN (NG-RAN) and a 5th generation core network (5GC). The NG-RAN consists of at least one NG-RAN node. The NG-RAN node is an entity corresponding to the BS 10 shown in FIG. 1. The NG-RAN node consists of at least one gNB 21 and/or at least one ng-eNB 22. The gNB 21 provides NR user plane and control plane protocol terminations towards the UE 11. The ng-eNB 22 provides E-UTRA user plane and control plane protocol terminations towards the UE 11.

The 5GC includes an access and mobility management function (AMF), a user plane function (UPF) and a session management function (SMF). The AMF hosts the functions, such as NAS security, idle state mobility handling, etc. The AMF is an entity including the functions of the conventional MME. The UPF hosts the functions, such as mobility anchoring, protocol data unit (PDU) handling. The UPF an entity including the functions of the conventional S-GW. The SMF hosts the functions, such as UE IP address allocation, PDU session control.

The gNBs and ng-eNBs are interconnected with each other by means of the Xn interface. The gNBs and ng-eNBs are also connected by means of the NG interfaces to the 5GC, more specifically to the AMF by means of the NG-C interface and to the UPF by means of the NG-U interface.

A protocol structure between network entities described above is described. On the system of FIG. 1 and/or FIG. 2, layers of a radio interface protocol between the UE and the network (e.g. NG-RAN and/or E-UTRAN) may be classified into a first layer (L1), a second layer (L2), and a third layer (L3) based on the lower three layers of the open system interconnection (OSI) model that is well-known in the communication system.

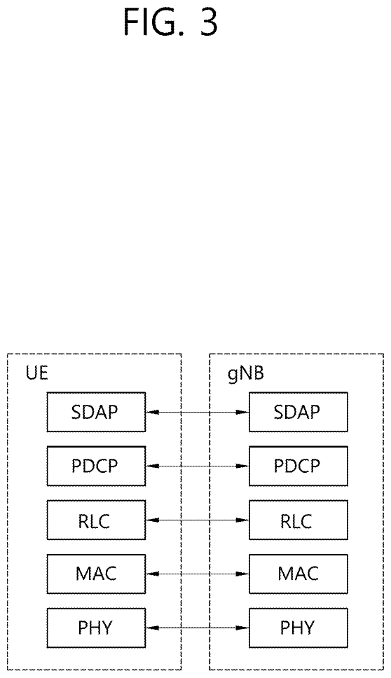

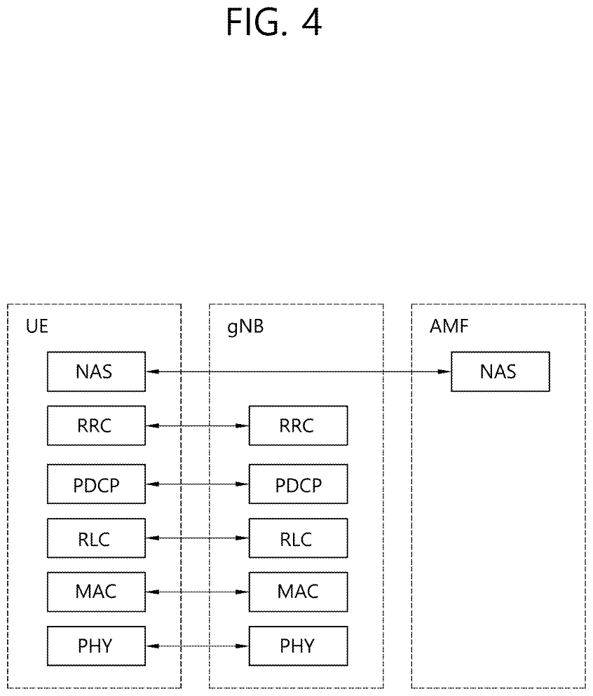

FIG. 3 shows a block diagram of a user plane protocol stack to which technical features of the present invention can be applied. FIG. 4 shows a block diagram of a control plane protocol stack to which technical features of the present invention can be applied. The user/control plane protocol stacks shown in FIG. 3 and FIG. 4 are used in NR. However, user/control plane protocol stacks shown in FIG. 3 and FIG. 4 may be used in LTE/LTE-A without loss of generality, by replacing gNB/AMF with eNB/MME.

Referring to FIG. 3 and FIG. 4, a physical (PHY) layer belonging to L1. The PHY layer offers information transfer services to media access control (MAC) sublayer and higher layers. The PHY layer offers to the MAC sublayer transport channels. Data between the MAC sublayer and the PHY layer is transferred via the transport channels. Between different PHY layers, i.e., between a PHY layer of a transmission side and a PHY layer of a reception side, data is transferred via the physical channels.

The MAC sublayer belongs to L2. The main services and functions of the MAC sublayer include mapping between logical channels and transport channels, multiplexing/de-multiplexing of MAC service data units (SDUs) belonging to one or different logical channels into/from transport blocks (TB) delivered to/from the physical layer on transport channels, scheduling information reporting, error correction through hybrid automatic repeat request (HARD), priority handling between UEs by means of dynamic scheduling, priority handling between logical channels of one UE by means of logical channel prioritization (LCP), etc. The MAC sublayer offers to the radio link control (RLC) sublayer logical channels.

The RLC sublayer belong to L2. The RLC sublayer supports three transmission modes, i.e. transparent mode (TM), unacknowledged mode (UM), and acknowledged mode (AM), in order to guarantee various quality of services (QoS) required by radio bearers. The main services and functions of the RLC sublayer depend on the transmission mode. For example, the RLC sublayer provides transfer of upper layer PDUs for all three modes, but provides error correction through ARQ for AM only. In LTE/LTE-A, the RLC sublayer provides concatenation, segmentation and reassembly of RLC SDUs (only for UM and AM data transfer) and re-segmentation of RLC data PDUs (only for AM data transfer). In NR, the RLC sublayer provides segmentation (only for AM and UM) and re-segmentation (only for AM) of RLC SDUs and reassembly of SDU (only for AM and UM). That is, the NR does not support concatenation of RLC SDUs. The RLC sublayer offers to the packet data convergence protocol (PDCP) sublayer RLC channels.

The PDCP sublayer belong to L2. The main services and functions of the PDCP sublayer for the user plane include header compression and decompression, transfer of user data, duplicate detection, PDCP PDU routing, retransmission of PDCP SDUs, ciphering and deciphering, etc. The main services and functions of the PDCP sublayer for the control plane include ciphering and integrity protection, transfer of control plane data, etc.

The service data adaptation protocol (SDAP) sublayer belong to L2. The SDAP sublayer is only defined in the user plane. The SDAP sublayer is only defined for NR. The main services and functions of SDAP include, mapping between a QoS flow and a data radio bearer (DRB), and marking QoS flow ID (QFI) in both DL and UL packets. The SDAP sublayer offers to 5GC QoS flows.

A radio resource control (RRC) layer belongs to L3. The RRC layer is only defined in the control plane. The RRC layer controls radio resources between the UE and the network. To this end, the RRC layer exchanges RRC messages between the UE and the BS. The main services and functions of the RRC layer include broadcast of system information related to AS and NAS, paging, establishment, maintenance and release of an RRC connection between the UE and the network, security functions including key management, establishment, configuration, maintenance and release of radio bearers, mobility functions, QoS management functions, UE measurement reporting and control of the reporting, NAS message transfer to/from NAS from/to UE.

In other words, the RRC layer controls logical channels, transport channels, and physical channels in relation to the configuration, reconfiguration, and release of radio bearers. A radio bearer refers to a logical path provided by L1 (PHY layer) and L2 (MAC/RLC/PDCP/SDAP sublayer) for data transmission between a UE and a network. Setting the radio bearer means defining the characteristics of the radio protocol layer and the channel for providing a specific service, and setting each specific parameter and operation method. Radio bearer may be divided into signaling RB (SRB) and data RB (DRB). The SRB is used as a path for transmitting RRC messages in the control plane, and the DRB is used as a path for transmitting user data in the user plane.

An RRC state indicates whether an RRC layer of the UE is logically connected to an RRC layer of the E-UTRAN. In LTE/LTE-A, when the RRC connection is established between the RRC layer of the UE and the RRC layer of the E-UTRAN, the UE is in the RRC connected state (RRC_CONNECTED). Otherwise, the UE is in the RRC idle state (RRC_IDLE). In NR, the RRC inactive state (RRC_INACTIVE) is additionally introduced. RRC_INACTIVE may be used for various purposes. For example, the massive machine type communications (MMTC) UEs can be efficiently managed in RRC_INACTIVE. When a specific condition is satisfied, transition is made from one of the above three states to the other.

A predetermined operation may be performed according to the RRC state. In RRC_IDLE, public land mobile network (PLMN) selection, broadcast of system information (SI), cell re-selection mobility, core network (CN) paging and discontinuous reception (DRX) configured by NAS may be performed. The UE shall have been allocated an identifier (ID) which uniquely identifies the UE in a tracking area. No RRC context stored in the base station.

In RRC_CONNECTED, the UE has an RRC connection with the network (i.e. E-UTRAN/NG-RAN). Network-CN connection (both C/U-planes) is also established for UE. The UE AS context is stored in the network and the UE. The RAN knows the cell which the UE belongs to. The network can transmit and/or receive data to/from UE. Network controlled mobility including measurement is also performed.

Most of operations performed in RRC_IDLE may be performed in RRC_INACTIVE. But, instead of CN paging in RRC_IDLE, RAN paging is performed in RRC_INACTIVE. In other words, in RRC_IDLE, paging for mobile terminated (MT) data is initiated by core network and paging area is managed by core network. In RRC_INACTIVE, paging is initiated by NG-RAN, and RAN-based notification area (RNA) is managed by NG-RAN. Further, instead of DRX for CN paging configured by NAS in RRC_IDLE, DRX for RAN paging is configured by NG-RAN in RRC_INACTIVE. Meanwhile, in RRC_INACTIVE, 5GC-NG-RAN connection (both C/U-planes) is established for UE, and the UE AS context is stored in NG-RAN and the UE. NG-RAN knows the RNA which the UE belongs to.

NAS layer is located at the top of the RRC layer. The NAS control protocol performs the functions, such as authentication, mobility management, security control.

The physical channels may be modulated according to OFDM processing and utilizes time and frequency as radio resources. The physical channels consist of a plurality of orthogonal frequency division multiplexing (OFDM) symbols in time domain and a plurality of subcarriers in frequency domain. One subframe consists of a plurality of OFDM symbols in the time domain. A resource block is a resource allocation unit, and consists of a plurality of OFDM symbols and a plurality of subcarriers. In addition, each subframe may use specific subcarriers of specific OFDM symbols (e.g. first OFDM symbol) of the corresponding subframe for a physical downlink control channel (PDCCH), i.e. L1/L2 control channel. A transmission time interval (TTI) is a basic unit of time used by a scheduler for resource allocation. The TTI may be defined in units of one or a plurality of slots, or may be defined in units of mini-slots.

The transport channels are classified according to how and with what characteristics data are transferred over the radio interface. DL transport channels include a broadcast channel (BCH) used for transmitting system information, a downlink shared channel (DL-SCH) used for transmitting user traffic or control signals, and a paging channel (PCH) used for paging a UE. UL transport channels include an uplink shared channel (UL-SCH) for transmitting user traffic or control signals and a random access channel (RACH) normally used for initial access to a cell.

Different kinds of data transfer services are offered by MAC sublayer. Each logical channel type is defined by what type of information is transferred. Logical channels are classified into two groups: control channels and traffic channels.

Control channels are used for the transfer of control plane information only. The control channels include a broadcast control channel (BCCH), a paging control channel (PCCH), a common control channel (CCCH) and a dedicated control channel (DCCH). The BCCH is a DL channel for broadcasting system control information. The PCCH is DL channel that transfers paging information, system information change notifications. The CCCH is a channel for transmitting control information between UEs and network. This channel is used for UEs having no RRC connection with the network. The DCCH is a point-to-point bi-directional channel that transmits dedicated control information between a UE and the network. This channel is used by UEs having an RRC connection.

Traffic channels are used for the transfer of user plane information only. The traffic channels include a dedicated traffic channel (DTCH). The DTCH is a point-to-point channel, dedicated to one UE, for the transfer of user information. The DTCH can exist in both UL and DL.

Regarding mapping between the logical channels and transport channels, in DL, BCCH can be mapped to BCH, BCCH can be mapped to DL-SCH, PCCH can be mapped to PCH, CCCH can be mapped to DL-SCH, DCCH can be mapped to DL-SCH, and DTCH can be mapped to DL-SCH. In UL, CCCH can be mapped to UL-SCH, DCCH can be mapped to UL-SCH, and DTCH can be mapped to UL-SCH.

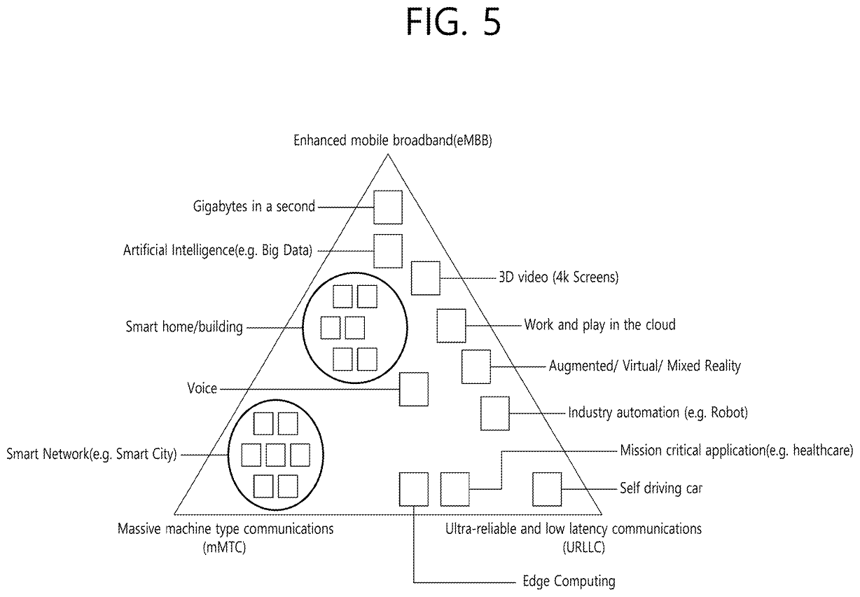

FIG. 5 shows examples of 5G usage scenarios to which the technical features of the present invention can be applied. The 5G usage scenarios shown in FIG. 5 are only exemplary, and the technical features of the present invention can be applied to other 5G usage scenarios which are not shown in FIG. 5.

Referring to FIG. 5, the three main requirements areas of 5G include (1) enhanced mobile broadband (eMBB) domain, (2) massive machine type communication (mMTC) area, and (3) ultra-reliable and low latency communications (URLLC) area. Some use cases may require multiple areas for optimization and, other use cases may only focus on only one key performance indicator (KPI). 5G is to support these various use cases in a flexible and reliable way.

eMBB focuses on across-the-board enhancements to the data rate, latency, user density, capacity and coverage of mobile broadband access. The eMBB aims ˜10 Gbps of throughput. eMBB far surpasses basic mobile Internet access and covers rich interactive work and media and entertainment applications in cloud and/or augmented reality. Data is one of the key drivers of 5G and may not be able to see dedicated voice services for the first time in the 5G era. In 5G, the voice is expected to be processed as an application simply using the data connection provided by the communication system. The main reason for the increased volume of traffic is an increase in the size of the content and an increase in the number of applications requiring high data rates. Streaming services (audio and video), interactive video and mobile Internet connectivity will become more common as more devices connect to the Internet. Many of these applications require always-on connectivity to push real-time information and notifications to the user. Cloud storage and applications are growing rapidly in mobile communication platforms, which can be applied to both work and entertainment. Cloud storage is a special use case that drives growth of uplink data rate. 5G is also used for remote tasks on the cloud and requires much lower end-to-end delay to maintain a good user experience when the tactile interface is used. In entertainment, for example, cloud games and video streaming are another key factor that increases the demand for mobile broadband capabilities. Entertainment is essential in smartphones and tablets anywhere, including high mobility environments such as trains, cars and airplanes. Another use case is augmented reality and information retrieval for entertainment. Here, augmented reality requires very low latency and instantaneous data amount.

mMTC is designed to enable communication between devices that are low-cost, massive in number and battery-driven, intended to support applications such as smart metering, logistics, and field and body sensors. mMTC aims ˜10 years on battery and/or ˜1 million devices/km². mMTC allows seamless integration of embedded sensors in all areas and is one of the most widely used 5G applications. Potentially by 2020, IoT devices are expected to reach 20.4 billion. Industrial IoT is one of the areas where 5G plays a key role in enabling smart cities, asset tracking, smart utilities, agriculture and security infrastructures.

URLLC will make it possible for devices and machines to communicate with ultra-reliability, very low latency and high availability, making it ideal for vehicular communication, industrial control, factory automation, remote surgery, smart grids and public safety applications. URLLC aims ˜1 ms of latency. URLLC includes new services that will change the industry through links with ultra-reliability/low latency, such as remote control of key infrastructure and self-driving vehicles. The level of reliability and latency is essential for smart grid control, industrial automation, robotics, drones control and coordination.

Next, a plurality of use cases included in the triangle of FIG. 5 will be described in more detail.

5G can complement fiber-to-the-home (FTTH) and cable-based broadband (or DOCSIS) as a means of delivering streams rated from hundreds of megabits per second to gigabits per second. This high speed can be required to deliver TVs with resolutions of 4K or more (6K, 8K and above) as well as virtual reality (VR) and augmented reality (AR). VR and AR applications include mostly immersive sporting events. Certain applications may require special network settings. For example, in the case of a VR game, a game company may need to integrate a core server with an edge network server of a network operator to minimize delay.

Automotive is expected to become an important new driver for 5G, with many use cases for mobile communications to vehicles. For example, entertainment for passengers demands high capacity and high mobile broadband at the same time. This is because future users will continue to expect high-quality connections regardless of their location and speed. Another use case in the automotive sector is an augmented reality dashboard. The driver can identify an object in the dark on top of what is being viewed through the front window through the augmented reality dashboard. The augmented reality dashboard displays information that will inform the driver about the object's distance and movement. In the future, the wireless module enables communication between vehicles, information exchange between the vehicle and the supporting infrastructure, and information exchange between the vehicle and other connected devices (e.g. devices accompanied by a pedestrian). The safety system allows the driver to guide the alternative course of action so that he can drive more safely, thereby reducing the risk of accidents. The next step will be a remotely controlled vehicle or self-driving vehicle. This requires a very reliable and very fast communication between different self-driving vehicles and between vehicles and infrastructure. In the future, a self-driving vehicle will perform all driving activities, and the driver will focus only on traffic that the vehicle itself cannot identify. The technical requirements of self-driving vehicles require ultra-low latency and high-speed reliability to increase traffic safety to a level not achievable by humans.

Smart cities and smart homes, which are referred to as smart societies, will be embedded in high density wireless sensor networks. The distributed network of intelligent sensors will identify conditions for cost and energy-efficient maintenance of a city or house. A similar setting can be performed for each home. Temperature sensors, windows and heating controllers, burglar alarms and appliances are all wirelessly connected. Many of these sensors typically require low data rate, low power and low cost. However, for example, real-time HD video may be required for certain types of devices for monitoring.

The consumption and distribution of energy, including heat or gas, is highly dispersed, requiring automated control of distributed sensor networks. The smart grid interconnects these sensors using digital information and communication technologies to collect and act on information. This information can include supplier and consumer behavior, allowing the smart grid to improve the distribution of fuel, such as electricity, in terms of efficiency, reliability, economy, production sustainability, and automated methods. The smart grid can be viewed as another sensor network with low latency.

The health sector has many applications that can benefit from mobile communications. Communication systems can support telemedicine to provide clinical care in remote locations. This can help to reduce barriers to distance and improve access to health services that are not continuously available in distant rural areas. It is also used to save lives in critical care and emergency situations. Mobile communication based wireless sensor networks can provide remote monitoring and sensors for parameters such as heart rate and blood pressure.

Wireless and mobile communications are becoming increasingly important in industrial applications. Wiring costs are high for installation and maintenance. Thus, the possibility of replacing a cable with a wireless link that can be reconfigured is an attractive opportunity in many industries. However, achieving this requires that wireless connections operate with similar delay, reliability, and capacity as cables and that their management is simplified. Low latency and very low error probabilities are new requirements that need to be connected to 5G.

Logistics and freight tracking are important use cases of mobile communications that enable tracking of inventory and packages anywhere using location based information systems. Use cases of logistics and freight tracking typically require low data rates, but require a large range and reliable location information.

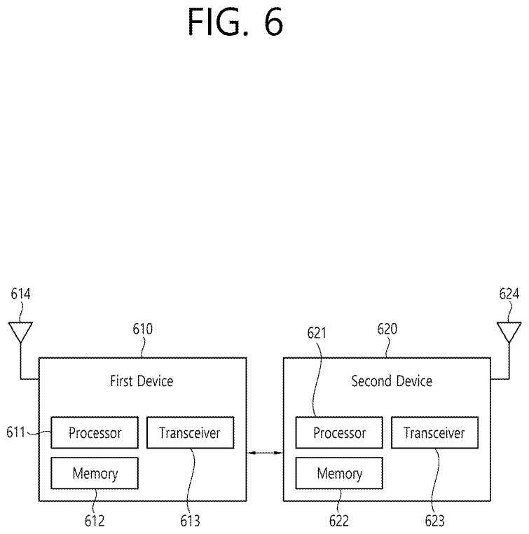

FIG. 6 shows an example of a wireless communication system to which the technical features of the present invention can be applied.

Referring to FIG. 6, the wireless communication system may include a first device 610 and a second device 620.

The first device 610 includes a base station, a network node, a transmitting UE, a receiving UE, a wireless device, a wireless communication device, a vehicle, a vehicle equipped with an autonomous driving function, a connected car, a drone, an unmanned aerial vehicle (UAV), an artificial intelligence (AI) module, a robot, an augmented reality (AR) device, a virtual reality (VR) device, a mixed reality (MR) device, a hologram device, a public safety device, an MTC device, an internet-of-things (IoT) device, a medical device, a fin-tech device (or, a financial device), a security device, a climate/environmental device, a device related to 5G services, or a device related to the fourth industrial revolution.

The second device 620 includes a base station, a network node, a transmitting UE, a receiving UE, a wireless device, a wireless communication device, a vehicle, a vehicle equipped with an autonomous driving function, a connected car, a drone, a UAV, an AI module, a robot, an AR device, a VR device, an MR device, a hologram device, a public safety device, an MTC device, an IoT device, a medical device, a fin-tech device (or, a financial device), a security device, a climate/environmental device, a device related to 5G services, or a device related to the fourth industrial revolution.

For example, the UE may include a mobile phone, a smart phone, a laptop computer, a digital broadcasting terminal, a personal digital assistant (PDA), a portable multimedia player (PMP), a navigation device, a slate personal computer (PC), a tablet PC, an ultrabook, a wearable device (e.g. a smartwatch, a smart glass, a head mounted display (HMD)). For example, the HMD may be a display device worn on the head. For example, the HMD may be used to implement AR, VR and/or MR.

For example, the drone may be a flying object that is flying by a radio control signal without a person boarding it. For example, the VR device may include a device that implements an object or background in the virtual world. For example, the AR device may include a device that implements connection of an object and/or a background of a virtual world to an object and/or a background of the real world. For example, the MR device may include a device that implements fusion of an object and/or a background of a virtual world to an object and/or a background of the real world. For example, the hologram device may include a device that implements a 360-degree stereoscopic image by recording and playing stereoscopic information by utilizing a phenomenon of interference of light generated by the two laser lights meeting with each other, called holography. For example, the public safety device may include a video relay device or a video device that can be worn by the user's body. For example, the MTC device and the IoT device may be a device that do not require direct human intervention or manipulation. For example, the MTC device and the IoT device may include a smart meter, a vending machine, a thermometer, a smart bulb, a door lock and/or various sensors. For example, the medical device may be a device used for the purpose of diagnosing, treating, alleviating, handling, or preventing a disease. For example, the medical device may be a device used for the purpose of diagnosing, treating, alleviating, or correcting an injury or disorder. For example, the medical device may be a device used for the purpose of inspecting, replacing or modifying a structure or function. For example, the medical device may be a device used for the purpose of controlling pregnancy. For example, the medical device may include a treatment device, a surgical device, an (in vitro) diagnostic device, a hearing aid and/or a procedural device, etc. For example, a security device may be a device installed to prevent the risk that may occur and to maintain safety. For example, the security device may include a camera, a closed-circuit TV (CCTV), a recorder, or a black box. For example, the fin-tech device may be a device capable of providing financial services such as mobile payment. For example, the fin-tech device may include a payment device or a point of sales (POS). For example, the climate/environmental device may include a device for monitoring or predicting the climate/environment.

The first device 610 may include at least one or more processors, such as a processor 611, at least one memory, such as a memory 612, and at least one transceiver, such as a transceiver 613. The processor 611 may perform the functions, procedures, and/or methods of the present invention described below. The processor 611 may perform one or more protocols. For example, the processor 611 may perform one or more layers of the air interface protocol. The memory 612 is connected to the processor 611 and may store various types of information and/or instructions. The transceiver 613 is connected to the processor 611 and may be controlled to transmit and receive wireless signals.

The second device 620 may include at least one or more processors, such as a processor 621, at least one memory, such as a memory 622, and at least one transceiver, such as a transceiver 623. The processor 621 may perform the functions, procedures, and/or methods of the present invention described below. The processor 621 may perform one or more protocols. For example, the processor 621 may perform one or more layers of the air interface protocol. The memory 622 is connected to the processor 621 and may store various types of information and/or instructions. The transceiver 623 is connected to the processor 621 and may be controlled to transmit and receive wireless signals.

The memory 612, 622 may be connected internally or externally to the processor 611, 612, or may be connected to other processors via a variety of technologies such as wired or wireless connections.

The first device 610 and/or the second device 620 may have more than one antenna. For example, antenna 614 and/or antenna 624 may be configured to transmit and receive wireless signals.

With the introduction of the new RRC state (i.e., RRC-INACTIVE state) in NR, the UE may incur minimum signaling, minimize power consumption, minimize resource costs in the network. In order to support this concept in NR, the UE may also be able to transmit the data without state transition from the RRC-INACTIVE to the RRC-CONNECTED. Early data transmission (EDT) refers to the operation of transmitting data before the RRC connection setup is completed, if the size of the data to be transmitted is small. In other words, according to the early data transmission, data transmission is allowed even when the UE is not in the RRC connection state.

Before EDT initiation, the UE may first check EDT parameters received from the network via broadcast messages (i.e. SIB2, SIB2-NB) or dedicated signaling (i.e. RRCConnectionReconfiguration). If the TB size in the EDT parameters is large enough to transmit early data transmission, the UE may initiate the EDT procedure by transmitting Msg1 (Preamble). The Msg1 may indicate that the UE initiates either the EDT procedure or the legacy procedure. If the CE level changes during Msg1 transmission attempts, however, before the completion of the EDT procedure, the size of Msg3 to be transmitted may be greater than the TB size allowed for the current CE level in the EDT parameters.

Therefore, a mechanism to decide whether or not the UE continues the EDT procedure when CE level changes during the EDT procedure should be considered.

According to an embodiment of the present invention, the UE may compare the Msg3 size for EDT with the TB size for the current CE level, when the CE level changes. The TB size may be previously received from the network. The UE may continue the EDT procedure only if the TB size for the current CE level is greater than or equal to the Msg3 size for EDT procedure. If the TB size for the current CE level is small for EDT procedure, the UE may perform the legacy RRC connection establishment procedure. In this case, the UE may inform the necessity of fallback to the upper layers.

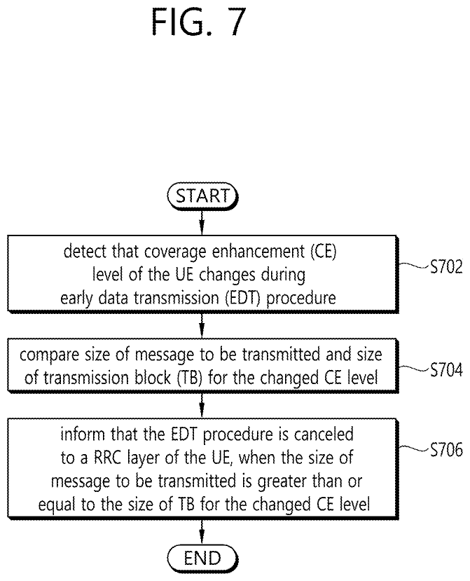

FIG. 7 shows a method for performing EDT procedure according to an embodiment of the present invention. The UE may be in radio resource control (RRC) idle state or RRC inactive state as an initial state.

In step S702, the UE (e.g. MAC layer) may detect that coverage enhancement (CE) level of the UE changes during early data transmission (EDT) procedure. The EDT procedure may be transmitting the message to be transmitted to a network in the RRC idle state or RRC inactive state. The UE may receive an indication indicating that a network supports the EDT procedure from the network, in prior.

In step S704, the UE (e.g. MAC layer) compare size of message to be transmitted and size of transmission block (TB) for the changed CE level. For this, the UE may receive information on size of at least one of TBs which are mapped to each CE level, before detecting the change of the CE level of the UE.

In step S706, the UE (e.g. MAC layer) may inform that the EDT procedure is canceled to a RRC layer of the UE, when the size of message to be transmitted is greater than or equal to the size of TB for the changed CE level.

Further, the UE may transmit the message to be transmitted to a network after a RRC connection establishment procedure is completed.

The random access resource selection procedure according to an embodiment of the present invention may be performed as follows:

For BL UEs or UEs in enhanced coverage or NB-IoT UEs, if EDT is initiated by the upper layers:
if the message size (UL data available for transmission plus MAC header and, where required, MAC control elements) is larger than the TB size signalled in edt-TBS for the selected enhanced coverage level for EDT; or
if the PRACH resource associated with EDT for the selected enhanced coverage level is not available:

indicate to upper layers that EDT is cancelled.

According to embodiments of the present invention, the UE may detect changes of CE level during the EDT procedure and determine whether to continue the on-going EDT procedure, so that a failure due to changes of CE level during the EDT procedure may be prevented.

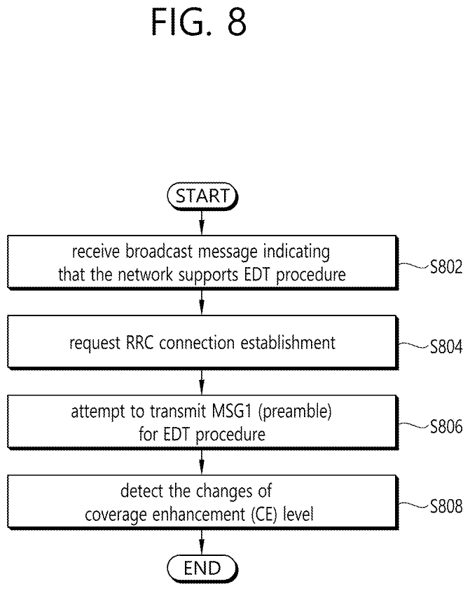

FIG. 8 shows a method for performing EDT procedure according to an embodiment of the present invention.

In step S802, the UE may receive broadcast message (i.e. SystemInformationBlockType2, SystemInformationBlockType2-NB) indicating that the network supports EDT procedure. The EDT procedure may be the data transmission procedure during RACH procedure. The broadcast message may include EDT parameters (i.e. at least one of TB size(s), preamble and mac-ContentionResolutionTimer for each CE level) as well as the indication of whether or not the network supports EDT for Control Plane CIoT optimisation and/or User Plane CIoT optimisation. The UE may store the EDT parameters; either RRC or MAC layer, or both layers store the necessary parameters. The EDT parameters may be updated by dedicated signaling (i.e. RRCConnectionReconfiguration).

In step S804, the upper layer may request RRC connection establishment. The upper layer may provide user data information such as data size, traffic type, and communication type. In step S806, if the access is not barred, the UE may attempt to transmit Msg1 (Preamble) for EDT procedure. If the UE is an NB-IoT UE, a BL UE or a UE in enhanced coverage, and when the number of transmission of the preamble reaches to a maximum number of transmission for next CE level (e.g. PREAMBLE_TRANSMISSION_COUNTER_CE=maxNumPreambleAttemptCE for the corresponding enhanced coverage level+1), the UE may reset the PREAMBLE_TRANSMISSION_COUNTER_CE, and the UE may consider to be in the next enhanced coverage level, when the CE is supported by the Serving Cell and the UE. Otherwise, the UE may stay in the current enhanced coverage level;

In step S808, the UE may detect that the enhanced coverage level changes in step S506. According to an embodiment of the present invention, RRC or MAC layer may detect the changes of coverage enhancement.

When the enhanced coverage level changes, the UE MAC layer may compare the stored TB size for the current coverage level with the size of Msg3 to be transmitted. The size of Msg3 for EDT procedure may be the size of MAC PDU including MAC header and MAC CE. The Msg3 may include the RRC message (i.e. RRCEarlyDataRequest) in Control Plane CIoT optimisation, while it includes the multiplexed RRC message (i.e. RRCConnectionResumeRequest) and the user data in User Plane CIoT optimisation. If the TB size is greater than or equal to the size of Msg3, the UE may continue the EDT procedure. Otherwise, the UE MAC may indicate that the UE cannot further continue the EDT procedure to the upper layers. In this case, the UE may fall-back to the legacy procedure.

Alternatively, the UE RRC layer may compare the stored TB size for the current coverage level with the size of Msg3 to be transmitted upon reception of the CE level change indication and the size of Msg3 to be transmitted from the lower layers. If the TB size is greater than or equal to the size of Msg3, the UE RRC may inform the lower layers to continue the EDT procedure. Otherwise, the UE RRC layer may fall-back and initiate the legacy procedure.

The MAC layer may receive CCCH PDU (for CP and UP) and DTCH PDU (for UP) from the RLC layer and initiates random access.

The MAC layer may receive random access response (RAR) with UL grant for the Msg3 transmission.

According to embodiments of the present invention, the UE may detect changes of CE level during the EDT procedure and determine whether to continue the on-going EDT procedure, so that a failure due to changes of CE level during the EDT procedure may be prevented.

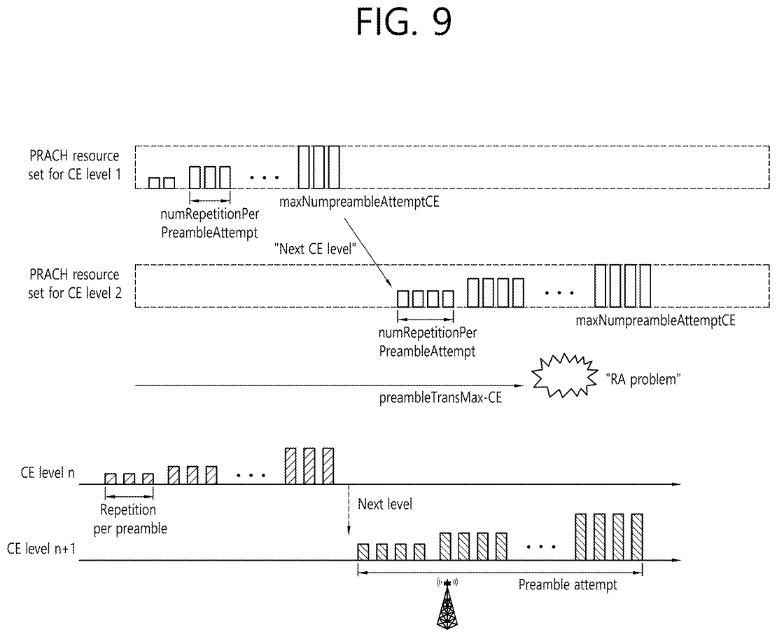

FIG. 9 shows an example of CE level change during the EDT procedure according to an embodiment of the present invention.

In FIG. 9, it is assumed that the current CE level of the UE may be ‘CE level 1’. When the number of transmission of the preamble reaches to a maximum number of transmission for next CE level (e.g. PREAMBLE_TRANSMISSION_COUNTER_CE=maxNumPreambleAttemptCE for the corresponding enhanced coverage level+1), the UE may reset the PREAMBLE_TRANSMISSION_COUNTER_CE, and the UE may consider to be in the next enhanced coverage level. In FIG. 9, the maximum number of transmission for CE level 1 may be 3 times, and the maximum number of transmission for CE level 2 may be 4 times. Because the number of transmission has been 4, the UE may consider that the CE level is changed from CE level 1 to CE level 2.

The UE (e.g. RRC layer) may receive the EDT parameters including the TB size for each CE level via a broadcast message. When the UE receives the EDT parameters via a dedicated message, the UE may update the previously received values.

The UE may store the EDT parameters received from the network. When the CE level changes, either the UE RRC or MAC layer may decide whether or not the UE continues the on-going EDT procedure. For this, the UE RRC and/or MAC layer may store the TB size per each CE level received from the network.

According to a first embodiment of the present invention, whether to continue the on-going EDT procedure may be decided by the MAC layer. Specifically, the UE MAC layer may store the TB size for each CE level in the EDT parameters received from the network. If the UE requests RRC connection establishment, the MAC layer may check if the Msg3 size for EDT is smaller than or equal to the TB size received from the network. If the CE level changes while the UE attempts to transmit Msg1, the UE MAC layer may check the Msg3 size for EDT with the stored TB size for the current CE level. If the TB size for the current CE level is larger than or equal to the Msg3 size, the UE MAC layer may continue the EDT procedure. If the TB size for the current CE level is smaller than the Msg3 size, the UE MAC layer may inform that the UE stops the EDT procedure to the upper layers. Then, the RRC layer may initiate the legacy procedure for RRC connection establishment.

According to a second embodiment of the present invention, whether to continue the on-going EDT procedure may be decided by the RRC layer. Specifically, the UE RRC layer may store the TB size for each CE level in the EDT parameters received from the network. If the UE requests RRC connection establishment, the RRC layer may check if the Msg3 size for EDT is smaller than or equal to the TB size received from the network. For the Msg3 size calculation, the RRC layer may apply the estimated MAC information size. If the CE level changes while the UE attempts to transmit Msg1, the UE MAC layer may inform the RRC layer of the change. Then, the RRC layer may check the Msg3 size for EDT with the stored TB size for the current CE level. If the TB size for the current CE level is larger than or equal to the Msg3 size, the UE RRC layer may inform that the UE continues the EDT procedure to the MAC layer. Then, the MAC layer may continue the EDT procedure. If the TB size for the current CE level is smaller than the Msg3 size, the UE RRC layer may initiate the legacy procedure for RRC connection establishment.

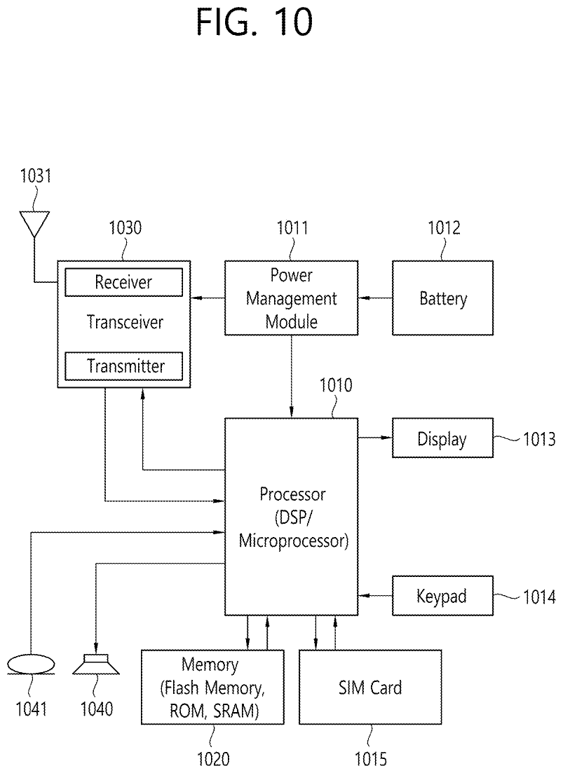

FIG. 10 shows more detailed UE to implement an embodiment of the present invention. The present invention described above for UE side may be applied to this embodiment.

A UE includes a processor 1010, a power management module 1011, a battery 1012, a display 1013, a keypad 1014, a subscriber identification module (SIM) card 1015, a memory 1020, a transceiver 1030, one or more antennas 1031, a speaker 1040, and a microphone 1041.

The processor 1010 may be configured to implement proposed functions, procedures and/or methods described in this description. Layers of the radio interface protocol may be implemented in the processor 1010. The processor 1010 may include ASIC, other chipset, logic circuit and/or data processing device. The processor 1010 may be an application processor (AP). The processor 1010 may include at least one of a digital signal processor (DSP), a central processing unit (CPU), a graphics processing unit (GPU), a modem (modulator and demodulator). An example of the processor 1010 may be found in SNAPDRAGON™ series of processors made by Qualcomm®, EXYNOS™ series of processors made by Samsung®, A series of processors made by Apple®, HELIO™ series of processors made by MediaTek®, ATOM™ series of processors made by Intel® or a corresponding next generation processor.

The processor 1010 may be configured to detect that coverage enhancement (CE) level of the UE changes during early data transmission (EDT) procedure. The EDT procedure may be transmitting the message to be transmitted to a network in the RRC inactive state. The UE may receive an indication indicating that a network supports the EDT procedure from the network, in prior.

The processor 1010 may be configured to compare size of message to be transmitted and size of transmission block (TB) for the changed CE level. For this, the UE may receive information on size of at least one of TBs which are mapped to each CE level, before detecting the change of the CE level of the UE.

The processor 1010 may be configured to inform that the EDT procedure is canceled to a RRC layer of the UE, when the size of message to be transmitted is greater than or equal to the size of TB for the changed CE level.

The processor 1010 may be configured to transmit the message to be transmitted to a network in RRC connected state after a RRC connection establishment procedure is completed.

The power management module 1011 manages power for the processor 1010 and/or the transceiver 1030. The battery 1012 supplies power to the power management module 1011. The display 1013 outputs results processed by the processor 1010. The keypad 1014 receives inputs to be used by the processor 1010. The keypad 1014 may be shown on the display 1013. The SIM card 1015 is an integrated circuit that is intended to securely store the international mobile subscriber identity (IMSI) number and its related key, which are used to identify and authenticate subscribers on mobile telephony devices (such as mobile phones and computers). It is also possible to store contact information on many SIM cards.

The memory 1020 is operatively coupled with the processor 1010 and stores a variety of information to operate the processor 1010. The memory 1020 may include ROM, RAM, flash memory, memory card, storage medium and/or other storage device. When the embodiments are implemented in software, the techniques described herein can be implemented with modules (e.g., procedures, functions, and so on) that perform the functions described herein. The modules can be stored in the memory 1020 and executed by the processor 1010. The memory 1020 can be implemented within the processor 1010 or external to the processor 1010 in which case those can be communicatively coupled to the processor 1010 via various means as is known in the art.

The transceiver 1030 is operatively coupled with the processor 1010, and transmits and/or receives a radio signal. The transceiver 1030 includes a transmitter and a receiver. The transceiver 1030 may include baseband circuitry to process radio frequency signals. The transceiver 1030 controls the one or more antennas 1031 to transmit and/or receive a radio signal.

The speaker 1040 outputs sound-related results processed by the processor 1010. The microphone 1041 receives sound-related inputs to be used by the processor 1010.

According to embodiments of the present invention, the UE may detect changes of CE level during the EDT procedure and determine whether to continue the on-going EDT procedure, so that a failure due to changes of CE level during the EDT procedure may be prevented.

In this document, the term “/” and “,” should be interpreted to indicate “and/or.” For instance, the expression “A/B” may mean “A and/or B.” Further, “A, B” may mean “A and/or B.” Further, “AB/C” may mean “at least one of A, B, and/or C.” Also, “A, B, C” may mean “at least one of A, B, and/or C.”

Further, in the document, the term “or” should be interpreted to indicate “and/or.” For instance, the expression “A or B” may comprise 1) only A, 2) only B, and/or 3) both A and B. In other words, the term “or” in this document should be interpreted to indicate “additionally or alternatively.”

In view of the exemplary systems described herein, methodologies that may be implemented in accordance with the disclosed subject matter have been described with reference to several flow diagrams. While for purposed of simplicity, the methodologies are shown and described as a series of steps or blocks, it is to be understood and appreciated that the claimed subject matter is not limited by the order of the steps or blocks, as some steps may occur in different orders or concurrently with other steps from what is depicted and described herein. Moreover, one skilled in the art would understand that the steps illustrated in the flow diagram are not exclusive and other steps may be included or one or more of the steps in the example flow diagram may be deleted without affecting the scope of the present disclosure.

What has been described above includes examples of the various aspects. It is, of course, not possible to describe every conceivable combination of components or methodologies for purposes of describing the various aspects, but one of ordinary skill in the art may recognize that many further combinations and permutations are possible. Accordingly, the subject specification is intended to embrace all such alternations, modifications and variations that fall within the scope of the appended claims.

What is claimed is:

1. A method performed by a user equipment (UE) in a wireless communication system, the method comprising:
detecting, by a MAC layer of the UE, that coverage enhancement (CE) level of the UE changes during early data transmission (EDT) procedure;
comparing, by the MAC layer of the UE, size of message to be transmitted and size of transmission block (TB) for the changed CE level; and
informing, by the MAC layer, that the EDT procedure is canceled to a RRC layer of the UE, when the size of message to be transmitted is greater than or equal to the size of TB for the changed CE level.

2. The method of claim 1, wherein the UE is in radio resource control (RRC) idle or RRC inactive state.

3. The method of claim 2, wherein the EDT procedure is transmitting the message to be transmitted to a network in the RRC idle or RRC inactive state.

4. The method of claim 1, further comprising:
transmitting the message to be transmitted to a network after a RRC connection establishment procedure is completed .

5. The method of claim 1, further comprising:
receiving an indication indicating that a network supports the EDT procedure from the network.

6. The method of claim 1, further comprising:
receiving information on size of at least one of TBs which are mapped to each CE level, before detecting the change of the CE level of the UE.

7. The method of claim 1, wherein the UE communicates with at least one of a mobile terminal, a network or autonomous vehicles other than the UE.

8. A user equipment (UE) in a wireless communication system, the UE comprising:
a transceiver for transmitting or receiving a radio signal; and
a processor coupled to the transceiver,
the processor configured to:
detect, by a MAC layer of the UE, that coverage enhancement (CE) level of the UE changes during early data transmission (EDT) procedure;
compare, by the MAC layer of the UE, size of message to be transmitted and size of transmission block (TB) for the changed CE level; and
inform, by the MAC layer, that the EDT procedure is canceled to a RRC layer of the UE, when the size of message to be transmitted is greater than or equal to the size of TB for the changed CE level.

9. The UE of claim 8, wherein the UE is in radio resource control (RRC) idle state or RRC inactive state.

10. The UE of claim 9, wherein the EDT procedure includes transmitting the message to be transmitted to a network in the RRC idle state or RRC inactive state.

11. The UE of claim 8, wherein the processor is further configured to:
transmit the message to be transmitted to a network after a RRC connection establishment procedure is completed .

12. The UE of claim 8, wherein the processor is further configured to:
receive an indication indicating that a network supports the EDT procedure from the network.

13. The UE of claim 8, wherein the processor is further configured to:
receive information on size of at least one of TBs which are mapped to each CE level, before detecting the change of the CE level of the UE.

14. The UE of claim 8, wherein the UE communicates with at least one of a mobile terminal, a network or autonomous vehicles other than the UE.

15. A processor for a wireless communication device in a wireless communication system,
wherein the processor is configured to control the wireless communication device to:
detect, by a MAC layer of the UE, that coverage enhancement (CE) level of the UE changes during early data transmission (EDT) procedure;
compare, by the MAC layer of the UE, size of message to be transmitted and size of transmission block (TB) for the changed CE level; and
inform, by the MAC layer, that the EDT procedure is canceled to a RRC layer of the UE, when the size of message to be transmitted is greater than or equal to the size of TB for the changed CE level.
